(19) United States
(12) Patent Application Publication
(10) Pub. No.: US 2011/0186685 A1
(43) Pub. Date: Aug. 4, 2011

(54) Thin-Film Composite Having Drag-Reducing Riblets and Method of Making the Same

(75) Inventors: Thomas K. Tsotsis, Orange, CA (US); Nicholas A. Kotov, Ann Arbor, MI (US)

(73) Assignee: The Boeing Company

(21) Appl. No.: 12/698,309

(22) Filed: Feb. 2, 2010

(51) Int. Cl. B64C 1/38; B05D 1/36; B32B 37/12; B32B 3/00; B32B 37/02; B32B 3/30

(52) U.S. Cl. 244/130; 427/258; 156/60; 428/172; 156/278; 428/167

(57) ABSTRACT

A film composite having generally parallel riblets reduces drag on the flow of fluid over a surface and may either be directly applied onto a substrate or secondarily bonded as an appliqué. The film composite is formed on a substrate layer by layer by sequentially assembling layers of a binder and an inorganic filler.

### CROSS REFERENCE TO RELATED APPLICATIONS

This application is related to co-pending U.S. patent application Ser. No. 11/954,330 filed Dec. 12, 2007, which is incorporated by reference herein in its entirety.

### TECHNICAL FIELD

This disclosure generally relates to techniques for reducing drag on fluid flowing over a surface, and deals more particularly with a film composite having drag-reducing riblets, and a method of making the composite.

### BACKGROUND

The use of aerodynamic features on the outer skin and components of aerospace vehicles is known to increase efficiency by reducing drag caused from surface friction. For example, the introduction of riblets into an aircraft's outer skin may reduce drag a modest amount by reducing skin friction exerted by a turbulent boundary layer at the surface of the skin. The riblets tend to inhibit lateral turbulent motions near the bottom of the boundary layer, which primarily comprise the motions associated with the near-wall stream-wise vortices, thereby reducing the overall rate of turbulence in the boundary layer by a modest percentage. These relatively small reductions in drag may improve operating efficiency sufficiently to generate significant savings in fuel cost.

The riblets mentioned above typically comprise a pattern of very small, alternating ridges and grooves aligned longitudinally, approximately in the direction of airflow over aerodynamic surfaces, such as, on an aircraft, such as the leading edges of wings and stabilizers. In the past, riblets have been placed on aerodynamic surfaces by forming V-shaped ridges in a flexible film which is bonded onto aerodynamic surfaces using an adhesive or other means. Such films containing riblets may have disadvantages in some applications including, without limitation, limited durability, limited hardness, stability under ultraviolet radiation, resistance to moisture and/or loss of geometric detail required to provide adequate drag reduction. Finally, existing techniques for manufacturing riblet structures involve the use of monolithic materials or blends of materials which may not be readily tailored to the particular application during fabrication.

Accordingly, there is a need for a method of fabricating riblet structures which may avoid the need for expensive tooling and machining, and which use materials that exhibit improved durability and flexibility in riblet formation while producing riblet features having greater dimensional accuracy.

### SUMMARY

The disclosed embodiments provide a method of producing a structure having controlled geometric surface features such as riblets that may reduce the drag on the flow of a fluid over a surface, such as an aircraft skin or the hull of a ship. The structure comprises a hybrid organic-inorganic nanocomposite that is fabricated layer by layer to form surface features that are both durable and dimensionally accurate. Layer-by-layer fabrication may be based on sequential adsorption of nanometer-thick monolayers of oppositely charged compounds such as charged nanoparticles to form a multi-layer structure with nanometer-level control over the architecture.

The method may be used to produce a riblet structure that is used as an appliqué over a surface, or to produce a tool that is used to fabricate an appliqué. In other embodiments, the riblet structure may be formed directly on the end-use surface, such as on an aircraft skin. Formation of the riblet structure layer by layer allows differing materials to be used in the various layers, thereby providing processing flexibility and riblet structures that may be tailored for particular applications. In still other embodiments, the skin of an aircraft may be coated with a film formed layer by layer. The surface of the film may be then embossed with an embossing tool, such as a roller with suitable pattern to define the structure. Chemical, thermal or photochemical curing steps may be added after embossing.

According to one embodiment, a method is provided of producing a structure for reducing drag on the flow of fluid over a surface. The method comprises forming riblets on a substrate, including assembling a multi-layer structure on the substrate by sequential adsorption on the substrate in solutions of differing compounds. In one embodiment, the solutions comprise oppositely charged compounds. The method provides a layer-by-layer fabrication of riblets formed by an inorganic filler held in a synthetic polymer binder. In one embodiment, the synthetic polymer includes polyvinyl alcohol and the inorganic filler includes Montmorillonite clay. The resulting composite structure may also exhibit transparency which may allow it to be used as a coating applied over painted aircraft surfaces.

According to another embodiment, a method is provided of forming geometric features on the surface of an aircraft skin. The method comprises forming a multi-layer, thin-film composite layer by layer on a substrate, and attaching the substrate to the skin. The substrate may be attached to the skin either by adhesive bonding or by curing the substrate on the skin.

According to a further embodiment, a method is provided of making a thin-film composite structure for reducing drag on the flow of fluid over a surface. The method comprises providing a substrate, and forming geometric features on the substrate layer by layer, including sequentially assembling layers of a binder and an inorganic filler.

According to still another embodiment, a composite appliqué is adapted to be applied to a surface for reducing drag on a fluid flowing over the surface. The appliqué comprises multiple, alternating layers of a binder and an inorganic compound assembled to form a plurality of generally parallel riblets. The binder may comprise polyvinyl alcohol, and the inorganic compound may be in the form of nanosheets. In one embodiment, the nanosheets may comprise an aluminosilicate. The nanosheets may comprise as much as approximately 90% by weight of the structure.

According to a further embodiment, a composite structure is provided for reducing drag on a fluid flowing over a surface. The composite structure comprises a plurality of nanosheets held in a polymer matrix and arranged to form a plurality of generally parallel riblets.

### BRIEF DESCRIPTION OF THE ILLUSTRATIONS

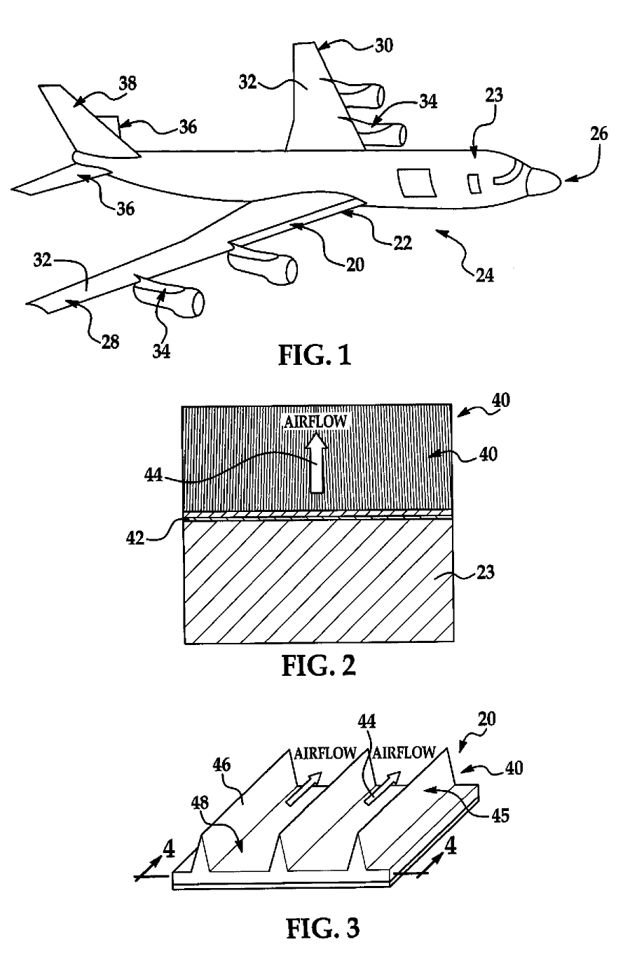

FIG. 1 is an illustration of a perspective view showing typical locations where a riblet appliqué may be placed on aerodynamic surfaces of an aircraft.

FIG. 2 is an illustration of a cross-sectional, perspective illustration of an aircraft skin having a riblet appliqué applied thereto.

FIG. 3 is an illustration of a perspective view better showing the geometry of the riblets illustrated in FIG. 2.

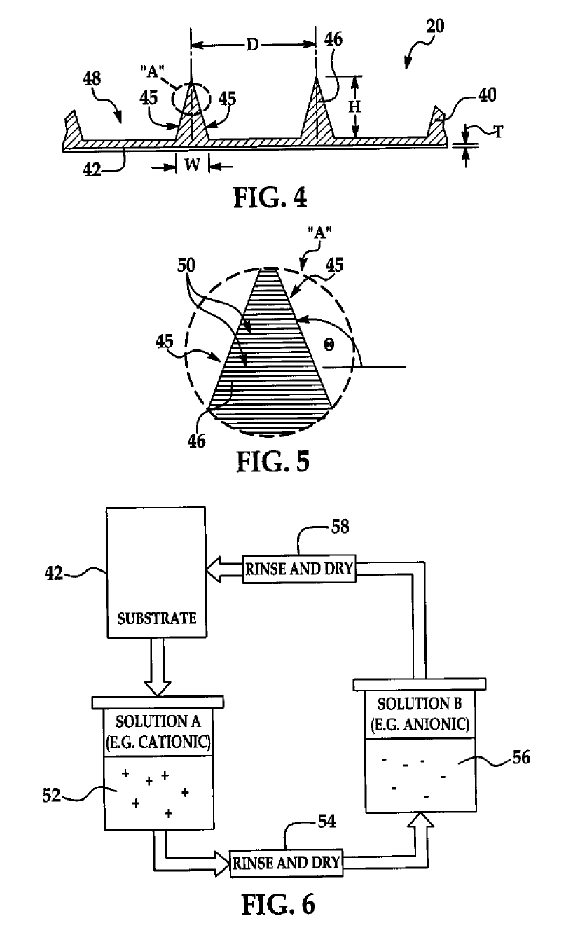

FIG. 4 is an illustration of a cross-sectional view taken along the line 4-4 in FIG. 3.

FIG. 5 is an illustration of the area designated as “A” in FIG. 4, better showing the individual layers of the riblet structure.

FIG. 6 is an illustration of a block diagram showing the components of a process for fabricating the riblet structure layer by layer through sequential adsorption of a substrate in solutions of oppositely charged compounds.

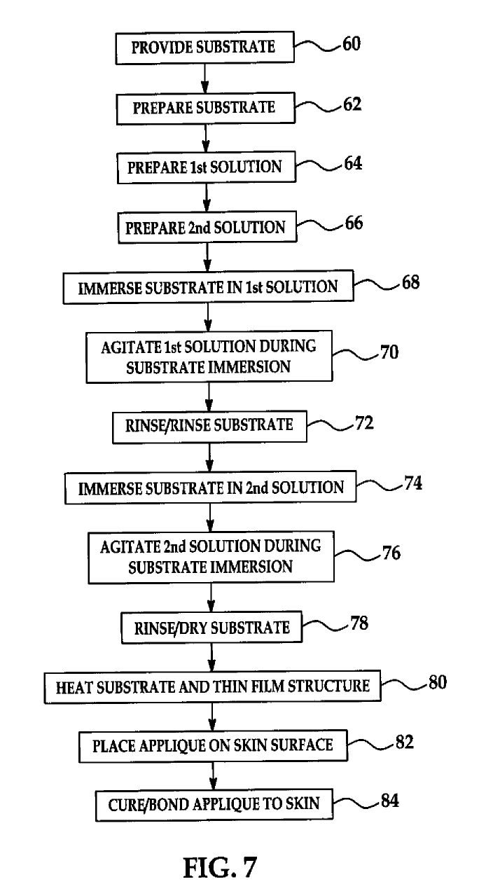

FIG. 7 is an illustration of a flow diagram showing the steps of a method of producing a riblet structure.

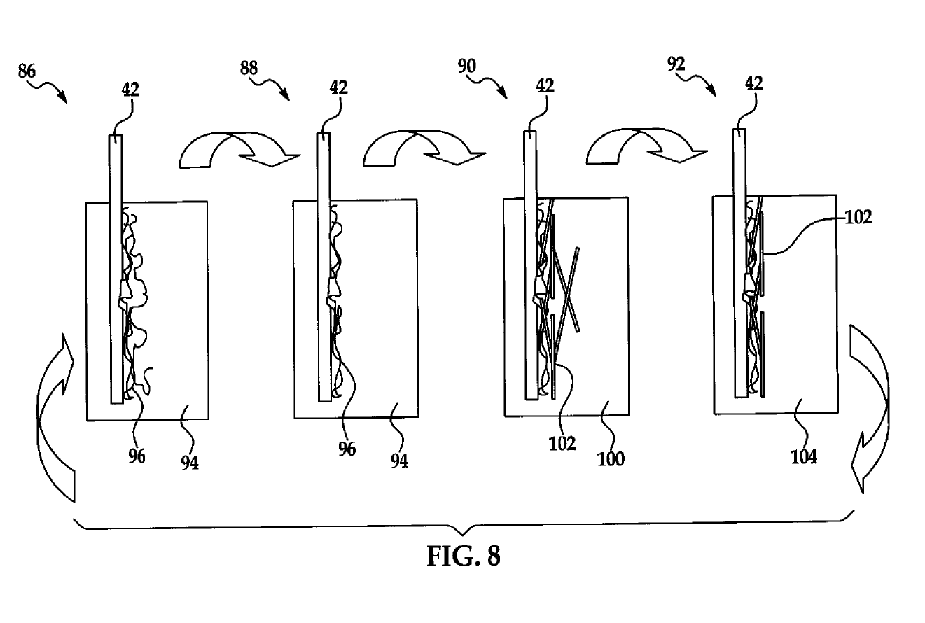

FIG. 8 is an illustration showing the sequential immersion of a substrate in solutions used to form a riblet structure layer by layer.

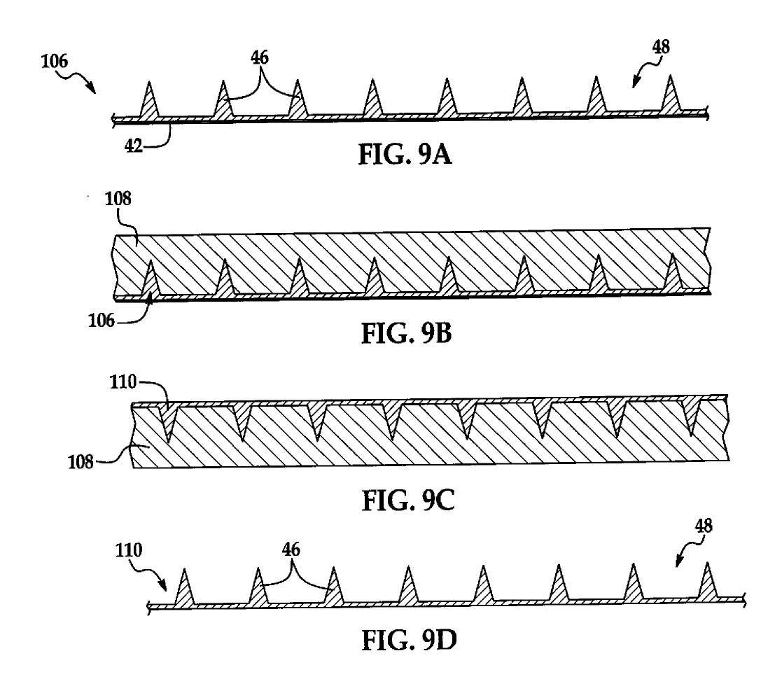

FIGS. 9A-9D are illustrations of cross-sectional views showing a method of making a tool layer by layer used to fabricate a riblet structure.

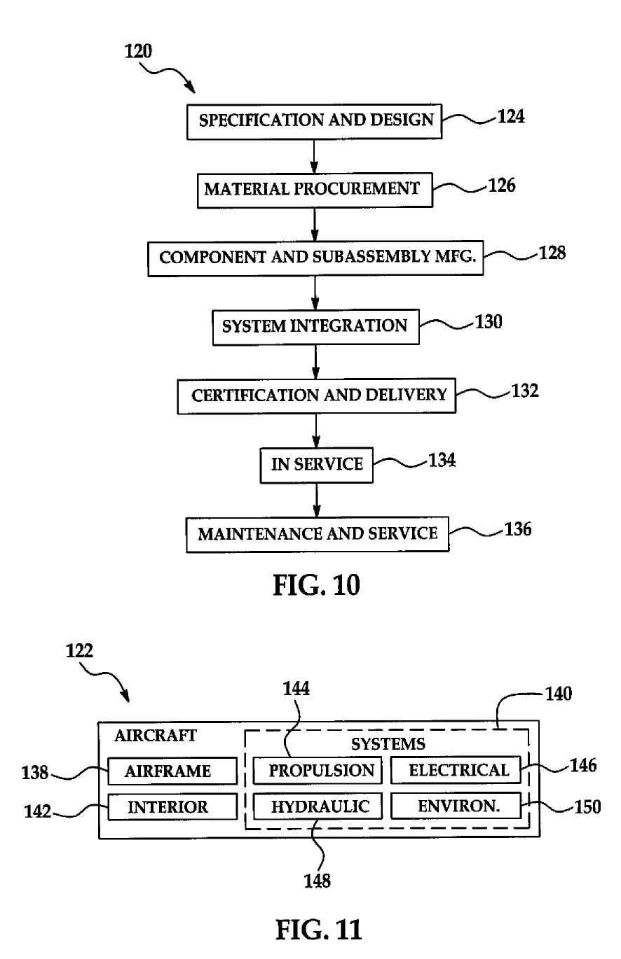

FIG. 10 is an illustration of a flow diagram of aircraft production and service methodology.

FIG. 11 is an illustration of a block diagram of an aircraft.

### DETAILED DESCRIPTION

Referring first to FIG. 1, according to one embodiment of the disclosure, a riblet appliqué 20 may be applied to aerodynamic surfaces 22 of an aerospace vehicle such as an aircraft 24. The aerodynamic surfaces 22 may comprise any part of the outer skin 23 on the aircraft 24 where drag may be advantageously reduced, such as a nose 26, leading edges 28, 30 of wings 32, engine pylons 34, the leading edges of horizontal stabilizers 36 and the leading edge of a vertical stabilizer 38, to name only a few. The riblet appliqué 20 may cover an entire section of a structure such as the entire nose 26, or only a portion of the section. The placement and area covered by the riblet appliqué 20 will vary with the aircraft application, but in general the maximum practical coverage may be up to approximately 80% to 85% of the wetted area of the aircraft 24. By optimizing the size and geometry of the riblet appliqué 20, as well as its placement, a 2% or more reduction in drag may be achieved by the aircraft 24 at cruise altitudes.

It should be noted here that while the disclosed embodiments will be described in connection with aerodynamic air flow over the surface of an aircraft, the embodiments may have other applications where it is desirable to reduce drag on a fluid flowing over a surface, For example, the appliqué 20 may be applied to the hull of a ship (not shown) to improve hydrodynamic flow of water over the ship's hull, or to the blades of a propeller (not shown) to increase the efficiency of the propeller.

Attention is now directed to FIGS. 2-5 which illustrate additional details of the riblet appliqué 20. The appliqué 20 includes a riblet structure 40 formed on a substrate 42. The riblet structure 40 comprises an alternating series of parallel ridge-like riblets 46 and groove-like valleys 48 which extend approximately parallel to the airflow 44 passing over a surface, such as the skin 23 of the aircraft 24 shown in FIG. 1. In the illustrated embodiment, each of the riblets 46 has a generally triangular sectional shape, however other sectional shapes are possible. The riblets 46 may have a height H, a base width W, and are separated by a center-to-center distance D. The dimensions H, W, D may be selected to suit the particular application. In the illustrated example, the sides 45 of each of the riblets 46 are inclined at a pre-selected angle θ to suit the particular application.

As best seen in FIG. 5, and as will be discussed in more detail below, the riblet structure 40 is formed from multiple thin film layers 50 which are built up layer by layer according to the disclosed method embodiments. Generally, the film layers 50 may comprise alternating layers of an inorganic compound and a synthetic polymer which acts as a matrix to bind the layers of inorganic compound into a consolidated, relatively hard and durable structure.

The substrate 42 has a thickness T (FIG. 4) that may vary with the application. Substrate 42 may be formed from any of a variety of materials that are both suitable for a particular application and are compatible with the materials from which the layers 50 of the riblet structure 40 are formed. For example, the substrate 42 may comprise a thin film of epoxy resin, a thermoplastic, a polymerizable monomer, sol-gel components, metals, plastics, ceramics and other materials. In some applications, it may be desirable that the substrate 42 is formed from a flexible material so that the appliqué 20 may be placed over and conform to curved or uneven surfaces, such as the curved leading edges 28, 30 of the aircraft shown in FIG. 1. On other embodiments, the riblet structure 40 may be formed layer by layer directly on the surface 22 of the aircraft 24, thus eliminating the need for an appliqué 20.

As will be discussed below in more detail, the disclosed embodiments provide a method for producing micron-scale, multi-layered structures such as the riblet structure 40, using layer-by-layer (LBL) deposition of single layers of nano-sized materials. The disclosed layer-by-layer process may be used to produce an appliqué or to produce tools (not shown) that are employed to form appliqués 20 and other structures using molding or other processes. The disclosed process permits the use of differing materials in the deposited layers 50 which allows a combination of materials to be tailored to better satisfy the requirements of a particular application.

Attention is now directed to FIG. 6 which illustrates one embodiment of a method of forming riblet structures 40 using LBL assembly. LBL assembly allows integrating the properties of organic and inorganic composites in thin films based on sequential adsorption of a substrate 42 in solutions 52, 56 of oppositely charged compounds. In the present example, one of the compounds may include positively charged particles dispersed in an aqueous cationic solution shown at 52. The other compound having negatively charged ions dispersed in an anionic aqueous solution is shown at 56. Individual film thickness layers 50 (FIG. 5) may typically be of nano-, micro-, and meso-scale and may be precisely controlled by adjusting processing conditions such as chemistry of components, post-processing steps, solution pH, ionic strength and immersion time.

In one practical example, one of the compounds dispersed in the aqueous solution 52 may comprise an inorganic compound such as a particular form of clay commonly known as Montmorillonite (MTM), and the second compound dispersed in the second aqueous solution 56 may comprise a soluble synthetic polymer such as polyvinyl alcohol (PVA). Montmorillonite is a layered aluminum and silicate mineral that occurs in two-dimensional particles called platelets, each having a size of approximately 1.0-1.5 nanometers with aspect ratios of between approximately 500:1 to over 1000:1, resulting in a relatively high surface area per unit volume. The platelets physically occur in nanometer-scale stacks or “deck of cards”. These platelets are also sometimes referred to as nanosheets. Other compounds may be employed in the LBL assembly to form the riblets, including but not limited to SiO₂, nanoparticles, graphene sheets, cellulose nanofibers, carbon nanotubes, dispersable aluminosilicates, carbon fibers, metal nano/micro particles, boron nitride nanotubes and others.

The PVA may be uncharged, unlike many other polymeric materials that may be used in LBL. Nevertheless, PVA may produce a stronger composite than would other polymers that undergo electrostatic attraction to the MTM clay nanosheets. The PVA/MTM pairing may exhibit desirable properties, including high efficiency of hydrogen bonding, and efficient load transfer. A substantial part of the efficient load transfer between the polymer and the inorganic building block may be attributed to cyclic cross linking to Al substitution present on the surface of MTM nanosheets and to Al atoms located along the edges of the MTM nanosheets.

Continuing with reference to FIG. 6, the substrate is cleaned and then immersed in the first solution 52 for a preselected period of time, during which a single monolayer 50 (FIG. 5) of the compound dispersed in solution 52 is formed. Then, the substrate 42 is removed from the solution 52, and is rinsed to remove excess compound material and dried at 54. The substrate 42 is subsequently immersed in solution 56 containing the second compound for a preselected period of time, thereby resulting in a second monolayer 50 of the compound in solution 56 being deposited on the layer 50 formed in solution 52. The substrate 42 is then rinsed again to remove excess compound material and dried again at 58 and the process is repeated to sequentially form alternating layers 50 of a relatively high-strength inorganic compound such as MTM, and a matrix material such as PVA which binds the MTM layers together into a substantially homogeneous structure. Nanoscale building blocks represented by the nanosheets of the MTM, effectively “self-assemble” in each monolayer during the deposition process, and are individually strong because they may be close to ideal materials. The particular riblet geometry or other desired pattern may be achieved using a mask (not shown), ink-jet like deposition to form the feature of the pattern, or pressure embossing.

The LBL assembly of the clay/polymer nano-composite results in a homogeneous structure formed by the planar orientation of the aluminosilicate nanosheets. The relatively high level of ordering of the nanosheets, combined with dense covalent and hydrogen bonding and stiffening of the polymer chains, may lead to highly effective load transfer between the nanosheets and the polymer binder. The process described above is particularly may be attractive because of the relatively low cost of the raw materials as well as the low cost of capital equipment required to carry out the process.

Attention is now directed to FIG. 7 which illustrates additional details of the method of forming the riblet structure 40, layer by layer. Beginning at 60, a suitable substrate 42 is provided which may be prepared at using cleaning, rinsing and drying. The first and second solutions 52, 56 of the compounds previously described are prepared at steps 64, 66 respectively. Next at step 68, the substrate 42 is immersed in the first solution 52 for a preselected period of time in order to form a first layer 50, during which it may be desirable, as shown at step 70 to agitate the solution to promote faster formation of a layer 50 of the first compound. The substrate 42 is removed from the first solution 52 and then rinsed and dried at step 72. Next, at 74, the substrate 42 is immersed in the second solution 54, thereby forming the next layer 50 of the second compound. Again, as shown at 76, it may be desirable to agitate the second solution during the substrate immersion. Next, the substrate 42 is rinsed and dried at 78. Optionally, the substrate 42 may then be heated at step 80. In those applications where the riblet structure 40 is formed as an appliqué 20, the appliqué 20 is placed on a surface such as the aircraft skin 23 (FIG. 1), as shown at step 82 and is affixed to the skin 23 either by curing the appliqué on the skin 23 or by adhesive bonding, as shown at step 84.

### EXAMPLE

In one practical example of the embodiments, Montmorillonite clay was dispersed under sonication for a period of 30 minutes in deionized water (18 MOhm) and sediment for 24 hours. The resulting supernatant was decanted and sonicated again for one hour to further reduce agglomeration of the Montmorillonite platelets. The resulting dispersion was nearly transparent and exhibited a state of dispersion required in the LBL method to obtain relatively high mechanical properties. PVA was dissolved in deionized water at 80° C. in the concentration of 0.2-0.5% by weight. The resulting fluid was completely transparent. A substrate was immersed into the solution of PVA for five minutes, then rinsed with water for ten seconds and immersed in the dispersion of clay for five minutes following which it was rinsed with water for ten seconds. Magnetic stirring was applied to the solution during deposition. The time of the deposition cycles may further be reduced with more vigorous agitation of the solution. The preceding sequence constituted one deposition cycle in which a bilayer consisting of a layer of clay and a PVA layer was deposited on the substrate. Following the deposition cycle, the substrate was analyzed and then heated to further improve the mechanical properties to 80° C. The heating cycle may be increased to approximately 120-130° C. in order to further improve mechanical properties of the resulting riblet structure.

It should be noted here that although only two solutions were employed to assemble the thin film layers in examples provided above, more than two solutions may be employed provided that they are chemically compatible with each other. The use of more than two solutions may result in tailoring of the resultant riblet structure 40 so as to exhibit qualities that are desirable in particular applications. Additionally, while in the examples provided above, compounds having opposite charges were dispersed in the two solutions, it may possible to build the riblet structure 40 layer by layer using compounds of non-charged molecules or particles, provided that sequential immersion in the non-charged solutions results in the formation of a gradually growing film.

For example, attention is now drawn to FIG. 8 which illustrates a sequence of processing steps for assembling a riblet structure 40 layer by layer using non-charged compounds. One complete cycle in which a bilayer comprising two layers respectively of an inorganic filler and a binder are shown at 86, 88, 90 and 92. At 86, a substrate 42 is first immersed in a solution 94 of a suitable polymer binder such as PVA resulting in the formation of a layer 96 of the polymer. Next, at 88, the substrate 42 is immersed in a solvent 98. Then, at 90, the substrate 42 is immersed in a solution 100 of a suitable nanomaterial or another polymer, resulting in the formation of a structural layer 102. Then, as shown at 92, the substrate 42 is immersed in another solvent 104 which may be in the same or different from the solvent 98 used at 88.

As previously mentioned, the disclosed method embodiments may be employed to produce a riblet appliqué or, a tool that may be used to reproduce a riblet structure suitable for use as an appliqué, or by direct deposition on the surface of a structure followed by embossing. Referring now to FIG. 9A, a riblet structure 106 comprising parallel riblets 46 alternating with valleys 48 is formed layer by layer on a substrate 42 using the processes described previously. Then, as shown in FIG. 9B a mold 108 is made of the riblet structure 106 using any suitable molding material. As shown in FIG. 9C the resulting mold 108 may then be used as a tool to mold a riblet structure 110 from any suitable molding materials. A suitable mold tool 108 may also be fabricated using other techniques including but not limited to micromachining, extrusion and photolithography. When removed from the mold 108, the resulting riblet structure 110 shown in FIG. 9D exhibits alternating riblets 46 and valleys 48 substantially similar to those of the tool shown in FIG. 9a.

Embodiments of the disclosure may find use in a variety of potential applications, particularly in the transportation industry, including for example, aerospace, marine and automotive applications. Thus, referring now to FIGS. 10 and 11, embodiments of the disclosure may be used in the context of an aircraft manufacturing and service method 120 as shown in FIG. 10 and an aircraft 122 as shown in FIG. 11. During pre-production, exemplary method 120 may include specification and design 124 of the aircraft 122 and material procurement 126. During production, component and subassembly manufacturing 128 and system integration 130 of the aircraft 122 takes place. The disclosed methods and thin film appliqué may be specified to be applied to components manufactured during step 128 and integrated in step 130. Thereafter, the aircraft 122 may go through certification and delivery 132 in order to be placed in service 134. While in service by a customer, the aircraft 122 is scheduled for routine maintenance and service 136 (which may also include modification, reconfiguration, refurbishment, and so on). The disclosed methods and appliqué may be applied to parts or components that are installed on the aircraft 122 during the maintenance and service 136.

Each of the processes of method 120 may be performed or carried out by a system integrator, a third party, and/or an operator (e.g., a customer). For the purposes of this description, a system integrator may include without limitation any number of aircraft manufacturers and major-system subcontractors; a third party may include without limitation any number of vendors, subcontractors, and suppliers; and an operator may be an airline, leasing company, military entity, service organization, and so on.

As shown in FIG. 11, the aircraft 122 produced by exemplary method 120 may include an airframe 138 with a plurality of systems 140 and an interior 142. Examples of high-level systems 142 include one or more of a propulsion system 144, an electrical system 146, a hydraulic system 148, and an environmental system 150. Any number of other systems may be included. The thin-film composite appliqué may be applied to one or more surfaces of the airframe 138.

The apparatus and methods embodied herein may be employed during any one or more of the stages of the production and service method 120. For example, components or subassemblies corresponding to production process 128 may be fabricated or manufactured in a manner similar to components or subassemblies produced while the aircraft 122 is in service. Also, one or more apparatus embodiments, method embodiments, or a combination thereof may be utilized during the production stages 128 and 130, for example, by substantially expediting assembly of or reducing the cost of an aircraft 122. Similarly, one or more of apparatus embodiments, method embodiments, or a combination thereof may be utilized while the aircraft 122 is in service, for example and without limitation, to maintenance and service 136.

Although the embodiments of this disclosure have been described with respect to certain exemplary embodiments, it is to be understood that the specific embodiments are for purposes of illustration and not limitation, as other variations will occur to those of skill in the art.

What is claimed:

1. A method of producing a structure for reducing drag on the flow of fluid over a surface, comprising:
forming riblets on a substrate, including assembling a multi-layer structure on the substrate by sequential adsorption of the substrate in solutions of differing compounds.

2. The method of claim 1, wherein assembling the multi-layer structure is performed by sequential adsorption of the substrate in two solutions respectively of oppositely charged compounds.

3. The method of claim 1, wherein the solutions of differing compounds include:
a first solution containing a soluble synthetic polymer, and
a second solution containing an inorganic filler.

4. The method of claim 3, wherein:
the soluble synthetic polymer is water-soluble and includes polyvinyl alcohol, and
the inorganic filler includes Montmorillonite clay.

5. The method of claim 1, further comprising:
using the substrate having the riblets formed thereon as a tool to produce an appliqué; and
applying the appliqué to the surface.

6. The method of claim 1, wherein the sequential absorption includes:
preparing a first aqueous dispersion of an inorganic filler,
preparing a second aqueous dispersion of a synthetic polymer,
alternately immersing the substrate in the first and second aqueous dispersions.

7. The method of claim 1, wherein the substrate forms part of an aircraft and the method further comprises curing the structure on the aircraft.

8. A tool produced by the method of claim 1.

9. A method of forming geometric features on the surface of an aircraft skin, comprising:
forming a multi-layer film composite layer by layer on a substrate; and
attaching the substrate to the skin.

10. The method of claim 9, wherein the layer-by-layer forming of the composite is performed by sequential adsorption of the substrate in solutions of differing compounds.

11. The method of claim 10, wherein the solutions include two solutions respectively of opposite electrical charges.

12. The method of claim 9, wherein attaching the substrate to the skin is performed by curing the substrate on the skin.

13. The method of claim 9, wherein attaching the substrate to the skin is performed by adhesively bonding the substrate to the skin.

14. Geometric features on the surface of an aircraft skin produced by the method of claim 9.

15. A method of making a thin film composite structure for reducing drag on the flow of fluid over a surface, comprising:
providing a substrate; and,
forming geometric features on the substrate layer by layer, including sequentially assembling layers of a binder and an inorganic filler.

16. A film composite structure produced by the method of claim 15.

17. A composite appliqué adapted to be applied to a surface for reducing drag on a fluid flowing over the surface, comprising:
multiple alternating layers of a binder and an inorganic compound assembled to form a plurality of generally parallel riblets.

18. The composite structure of claim 17, wherein the binder is polyvinyl alcohol.

19. The composite structure of claim 17, wherein the inorganic compound is in the form of nanosheets.

20. The composite structure of claim 19, wherein the nanosheets are an aluminosilicate.

21. The composite structure of claim 19, wherein the nanosheets are Montmorillonite platelets.

22. The composite structure of claim 19, wherein the nanosheets comprise at least approximately 90% by weight of the structure.

23. A composite structure for reducing drag on a fluid flowing over a surface, comprising:
a plurality of nanosheets held in a polymer matrix and arranged to form a plurality of generally parallel riblets.

24. A method of forming an aerodynamic surface on the skin of an aircraft, comprising:
forming a composite appliqué having generally parallel riblets for reducing drag on the flow of air over the skin, including
providing a substrate,
forming a multi-layer thin film on the substrate by sequential adsorption of the substrate in a first solution of polyvinyl alcohol and a second solution of Montmorillonite clay,
agitating each of the solutions while the substrate is immersed therein,
heating the substrate having the multi-layer firm thereon,
placing the appliqué of the skin; and
curing the appliqué on the skin.

25. An aerodynamic appliqué for reducing drag on air flowing over the surface of an aircraft skin, comprising:
a multi-layer thin film composite including generally parallel riblets in the surface thereof, the thin film including alternating layers of a polyvinyl alcohol binder and Montmorillonite platlets held in the binder,
wherein the Montmorillonite platlets forming at least approximately 90% by weight of the thin film.
